(19) United States
(12) Patent Application Publication
(10) Pub. No.: US 2011/0187033 A1
(43) Pub. Date: Aug. 4, 2011

(54) BELLOWS-TYPE SHOCK-ABSORBING DEVICE

(75) Inventor: MAO-LIANG LIN, TAIPEI (TW)

(73) Assignee: PANEW COMPANY LIMITED, TAIPEI COUNTY (TW)

(21) Appl. No.: 12/826,685

(22) Filed: Jun. 30, 2010

(30) Foreign Application Priority Data
Jan. 29, 2010 (TW) 099102698

(51) Int. Cl. F16F 9/43

(52) U.S. Cl. 267/122

(57) ABSTRACT

The present invention discloses a bellows-type shock-absorbing device, which comprises an outer pipe, an inner pipe, and a chamber enclosed by the inner and outer pipes. The outer pipe has a bellows structure. At least one orifice is disposed on the surface of the outer pipe for injecting fluids into the chamber. By means of injecting different ratios of liquid and gas into the chamber, it is able to provide the bellows-type shock-absorbing device with an adjustable shock-absorbing performance.

### FIELD

The exemplary embodiment(s) of the present invention relates to a field of shock-absorbing device. More specifically, the exemplary embodiment(s) of the present invention relates to bellows-type shock-absorbing device for adjustable stiffness.

### BACKGROUND

The metal bellows-type element (hereinafter “bellows”) is a kind of piping for industrial application. The surface of the bellows is wavy, which is arranged to lengthen and shorten axially like springs and can be flexible to some degree. This characteristic is the main difference between the conventional straight pipes and the bellows.

At present, bellows-type elements are massively applied to industrial fluid piping equipments. In general, when the variation of the temperature and the pressure inside and outside of the bellows is greater than the bearable range of the bellows-type elements, structural deformation of the bellows will be produced. Therefore, the structure of the bellows has to be designed to accept foreseeable variations of the temperature and the pressure inside and outside the bellows. The mechanical strength and the structural stiffness of the bellows are decided by its manufacturing method, selection of the metallic materials, thickness of the pipe wall, and the dimension.

As above mentioned, the bellows may be arranged as the mechanical seal, flexible element, and valve body of piping systems for industrial applications, and meanwhile provides sufficient mechanical strength to accept the external force. In addition, spontaneous shock may be produced during the operation of the mechanical apparatus, such as the vibrating source caused by the reciprocating motion or shocks produced by the fluid while passing through the pipes. The wavy appearance of the bellows enables the bellows to have the flexibility to slow down the transmission of the shock wave produced by the operation of the mechanical apparatus.

A flexible element, such as a spring, with a fixed stiffness, has to be disposed on prior shock-absorbing device to maintain the whole stiffness of shock-absorbing device. The system characteristics of the new shock-absorbing device corresponding to the coefficients of the stiffness of the flexible element must be re-designed while applying the flexible element to different shock-absorbing devices. Therefore, this invention discloses a bellows-type shock-absorbing device with adjustable stiffness to improve the design of the shock-absorbing device.

### SUMMARY

A bellows-type shock-absorbing device with adjustable stiffness is provided in the present invention to overcome the fixed stiffness issue of prior shock-absorbing device.

The present invention provides a bellows-type shock-absorbing device which comprises an outer pipe and an inner pipe, in which the inner pipe is disposed inside the outer pipe. The two ends of the outer pipe and the inner pipe at the same side are closed ends with a gap kept therebetween. And at the open ends on the other side, the structure of the outer wall of the inner pipe is able to connect to the inner wall of the outer pipe, to thereby form a chamber. An accommodating space exits between the original open end and the close end of the inner pipe. The outer pipe comprises a strait pipe portion and a bellows. At least one orifice is disposed on the surface of the strait pipe portion of the outer pipe for injecting fluids to the chamber. This kind of the shock-absorbing device is called the internal pressure shock-absorbing device because the fluid is inside the bellows.

In the bellows-type shock-absorbing device of this invention, a force-bearing base is disposed on the closed ends of the outer pipe and the inner pipe opposite to the chamber, and the force-bearing base may be connected to a first compressive/tensile screw.

In the bellows-type shock-absorbing device of this invention, a pressure-bearing base may be applied to connect the inner pipe to the outer pipe.

The present invention provides another bellows-type shock-absorbing device, which comprises an outer pipe and an inner pipe. The inner pipe is disposed inside the outer pipe, in which the ends of the same direction of the inner pipe and the outer pipe are closed, and a gap is kept there between. And at the open ends of the other side, a chamber is formed by connecting the outer wall of the inner pipe and the inner wall of the outer pipe. An accommodating space exits between the original open end and the close end of the inner pipe. The inner pipe comprises a strait pipe portion and a bellows. At least one orifice is disposed on the surface of the outer pipe for injecting fluids to the chamber. This kind of the shock-absorbing device is called the external pressure shock-absorbing device because the fluid is outside the bellows.

In the bellows-type shock-absorbing device of this invention, a pressure-bearing base may be connected to a force-bearing base at the inner pipe side by a pipe column body.

In the bellows-type shock-absorbing device of this invention, by means of injecting fluids into the chamber, wherein the fluids comprise different ratios of liquid and gas, it is able to give the bellows-type shock-absorbing device an adjustable shock-absorbing performance.

In summary, the bellows-type shock-absorbing device in accordance with the present invention may have one or more of the following advantages:

(1) The bellows-type shock-absorbing device comprises a bellows, which enables to absorb various kinds of shocks produced by the source of vibrations, such as the axial shock, the lateral shock, the flexural deformation, etc.

(2) The bellows-type shock-absorbing device may have an adjustable stiffness, by means of injecting fluids into the chamber, wherein the fluids comprise different ratios of liquid and gas. And it is therefore able to provide the bellows-type shock-absorbing device with the variable structural stiffness. In accordance with the range of the vibration frequency of the shock resource body, the bellows-type shock absorbing device adjusts the stiffness thereof to achieve excellent shock-absorbing performance.

(3) The bellows-type shock-absorbing device comprises internal pressure shock-absorbing device and external pressure shock-absorbing device. It provides shock-absorbing device with various performance characteristics for different purposes by using compressive/tensile screws, pressure-bearing bases, sleeve bodies, and position limiting blocks.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The'exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of internal pressure shock-absorbing device of bellows-type shock-absorbing device of the present invention.

FIG. 2 illustrates a schematic diagram for a first embodiment of internal pressure shock-absorbing device of bellows-type shock-absorbing device of the present invention.

FIG. 3 illustrates a schematic diagram for a second embodiment of internal pressure shock-absorbing device of bellows-type shock-absorbing device of the present invention.

FIG. 4, illustrates a schematic diagram for a third embodiment of internal pressure shock-absorbing device of bellows-type shock-absorbing device of the present invention.

FIG. 5 illustrates a schematic diagram of external pressure shock-absorbing device of bellows-type shock-absorbing device of the present invention.

FIG. 6 illustrates a schematic diagram for a first embodiment of external pressure shock-absorbing device of bellows-type shock-absorbing device of the present invention.

FIG. 7 illustrates a schematic diagram for a second embodiment of external pressure shock-absorbing device of bellows-type shock-absorbing device of the present invention.

### DETAILED DESCRIPTION

Exemplary embodiments of the present invention are described herein in the context of bellows-type shock-absorbing device.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

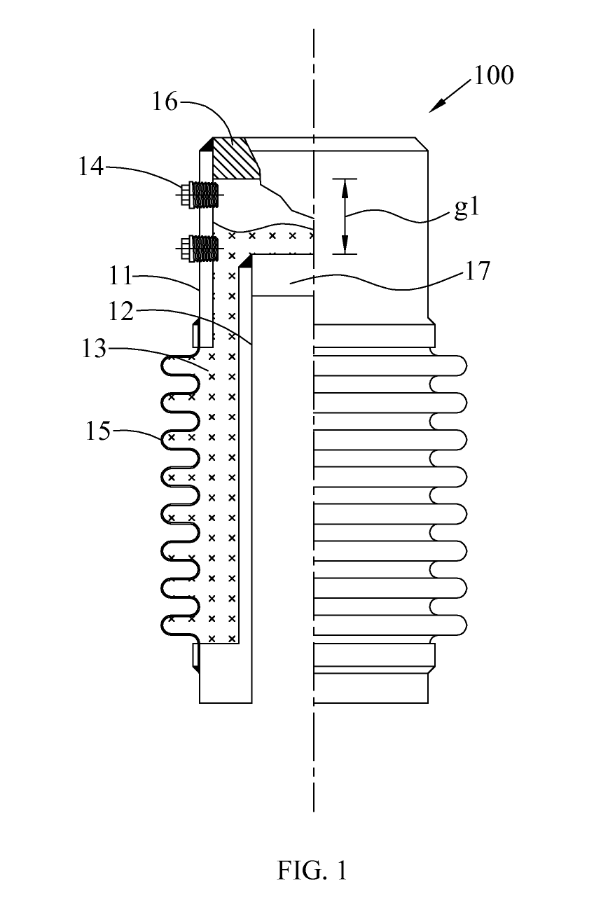

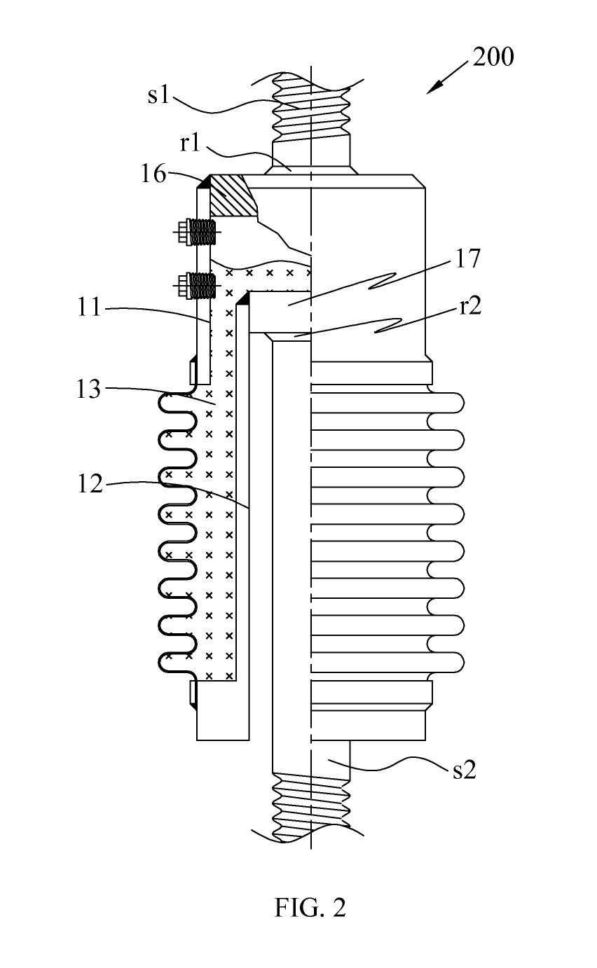

FIG. 1 illustrates a schematic diagram of internal pressure shock-absorbing device of bellows-type shock-absorbing device of the present invention. In the figure, an internal pressure shock-absorbing device 100 comprises an outer pipe 11, an inner pipe 12, and at least one orifice 14 disposed on the surface of the outer pipe 11 for injecting fluids to a chamber 13 formed by the outer pipe 11 and the inner pipe 12. A first gap g1 arranged to resist the device over-compression is kept between a closed end 16 of the outer pipe 11 and a closed end 17 of the inner pipe 12. The outer pipe 11 comprises a bellows 15. FIG. 2 to FIG. 4 illustrate schematic diagram for embodiments of internal pressure shock-absorbing device of the present invention. For internal pressure shock-absorbing device, the injected fluid is inside the bellows 15. As follows:

FIG. 2 illustrates a schematic diagram for a first embodiment of internal pressure shock-absorbing device of bellows-type shock-absorbing device of the present invention. In the figure, an internal pressure shock-absorbing device 200 is shown. A first force-bearing base r1 is disposed on the closed end 16 of the outer pipe 11 opposite to the chamber 13, and the first force-bearing base r1 is connected to a first compressive/tensile screw s1. A second force-bearing base r2 is disposed on the closed end 17 of the inner pipe 12 opposite to the chamber 13, and the second force-bearing base r2 is connected to a second compressive/tensile screw s2.

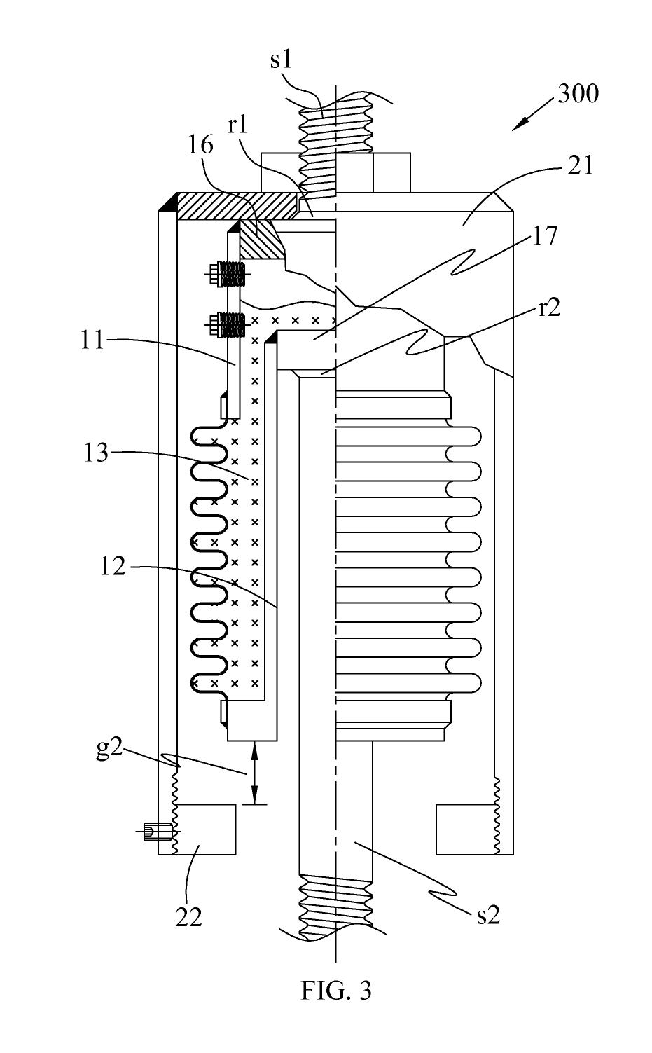

FIG. 3 illustrates a schematic diagram for a second embodiment of internal pressure shock-absorbing device of bellows-type shock-absorbing device of the present invention. In the figure, an internal pressure shock-absorbing device 300 is shown. The first force-bearing base r1 is disposed on the closed end 16 of the outer pipe 11 opposite to the chamber 13, and the first force-bearing base r1 is connected to the first compressive/tensile screw s1. The second force-bearing base r2 is disposed on the closed end 17 of the inner pipe 12 opposite to the chamber 13, and the second force-bearing base r2 is connected to the second compressive/tensile screw s2. In addition, a first sleeve body 21 is disposed around the outer pipe 11 to resist the fluid ejection while device failure. One end of the first sleeve body 21 is through the first compressive/tensile screw s1 and is in contact with the first force-bearing base r1. The other end of the first sleeve body 21 is correspondingly extended to the second compressive/tensile screw s2. At least one position limiting block 22 arranged to resist a maximum displacement of the internal pressure shock-absorbing device 300 is disposed on the other end of the first sleeve body 21, a second gap g2 is kept between the position limiting block 22 and the second ends of the outer pipe 11- and the inner pipe 12.

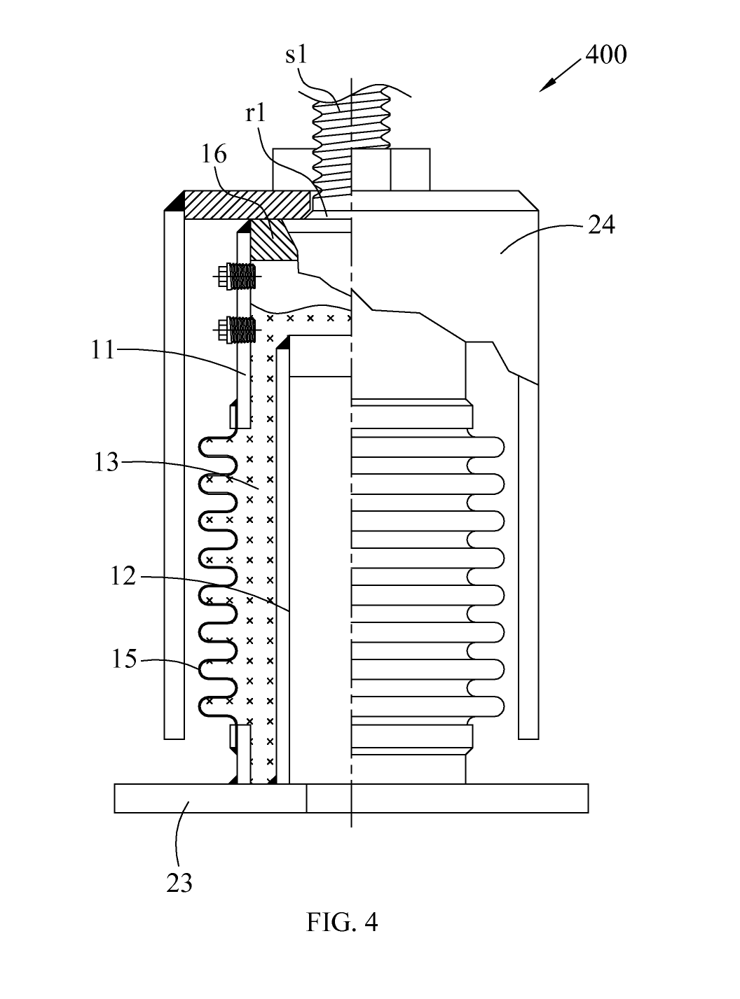

FIG. 4 illustrates a schematic diagram for a third embodiment of internal pressure shock-absorbing device of bellows-type shock-absorbing device of the present invention. In the figure, an internal pressure shock-absorbing device 400 is shown. The first force-bearing base r1 is disposed on the closed end 16 of the outer pipe 11 opposite to the chamber 13. The first force-bearing base r1 is connected to the first compressive/tensile screw s1. A pressure-bearing base 23 is connected to the second end of the outer pipe 11 and the second end of the inner pipe 12. The pressure-bearing base 23 is arranged to seal the second end of the outer pipe 11 and the second end of the inner pipe 12. In addition, a second sleeve body 24 is disposed around the outer pipe 11 to resist the fluid ejection while device failure. One end of the second sleeve body 24 is arranged through the first compressive/tensile screw s1 and is in contact with the first force-bearing base r1, and the other end of the second sleeve body 24 is correspondingly extended to the bellows 15.

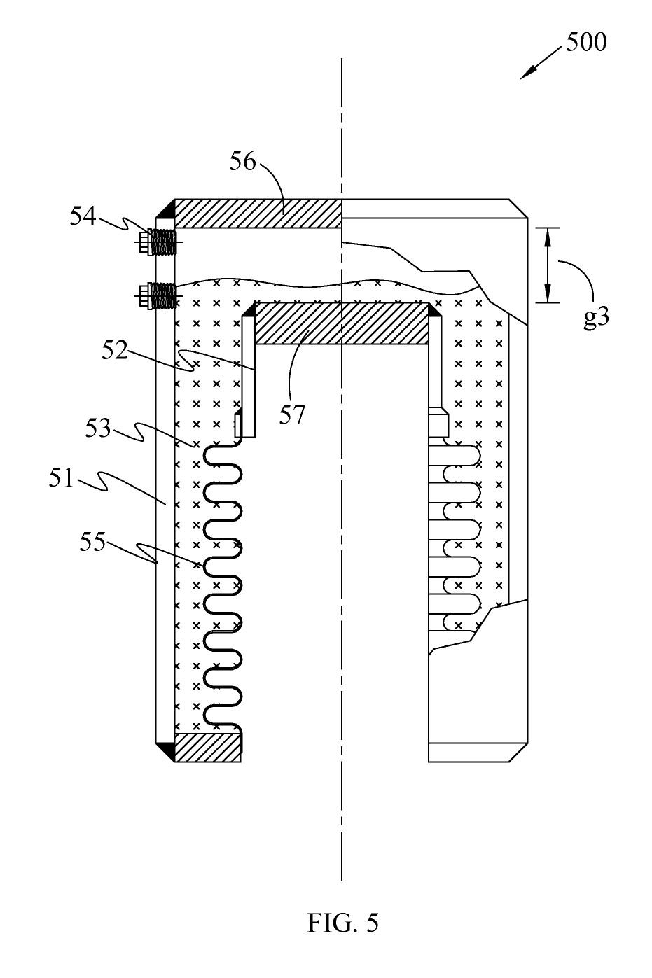

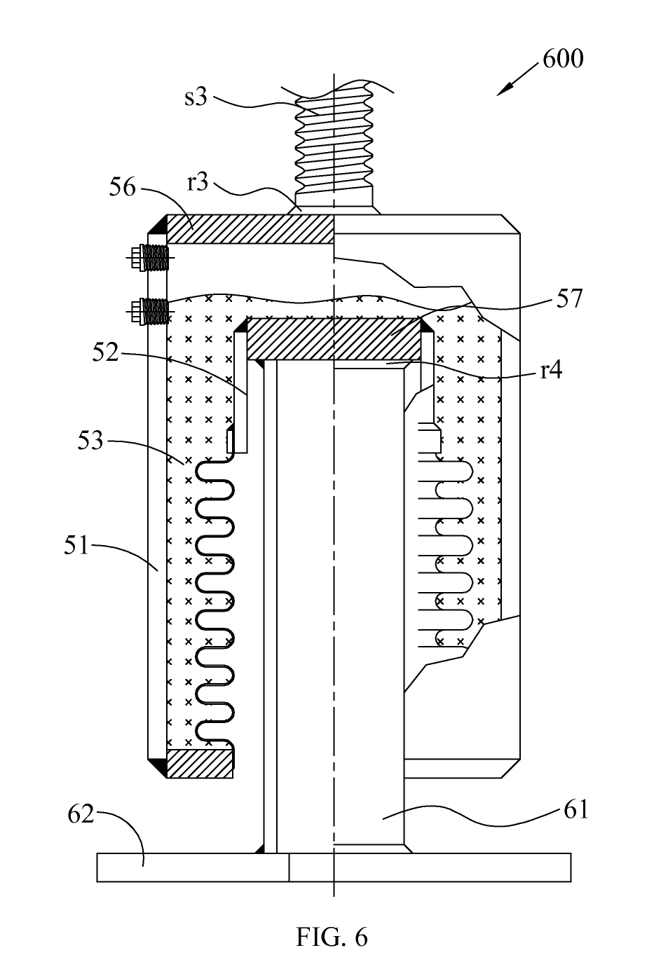

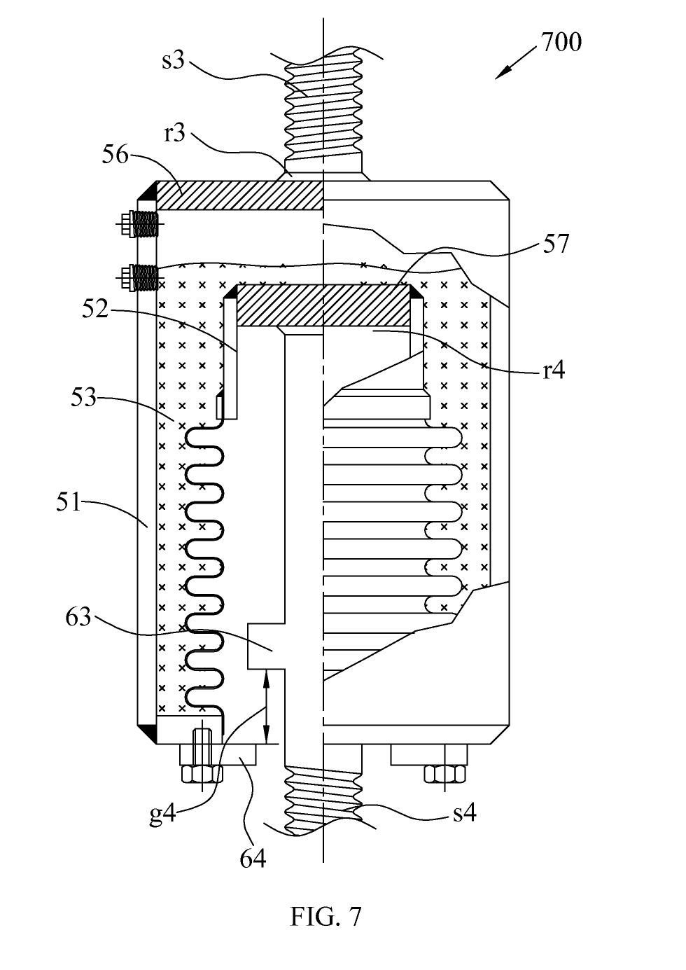

FIG. 5 illustrates a schematic diagram of external pressure shock-absorbing device of bellows-type shock-absorbing device of the present invention. In the figure, an external pressure shock-absorbing device 500 is shown, which comprises an outer pipe 51, an inner pipe 52, and at least one orifice 54 disposed on the surface of the outer pipe 51 for injecting fluids to a chamber 53 formed by the outer pipe 51 and the inner pipe 52. A third gap g3 arranged to resist the device over-compression is kept between a closed end 56 of the outer pipe 51 and a closed end 57 of the inner pipe 52. The inner pipe 52 comprises a bellows 55. FIG. 6 to FIG. 7 illustrate schematic diagrams for embodiments of the external pressure shock-absorbing devices of the present invention. For external pressure shock-absorbing device, the injected fluid is outside the bellows 55. As follows:

FIG. 6 illustrates a schematic diagram for a first embodiment of external pressure shock-absorbing device of bellows-type shock-absorbing device of the present invention. In the figure, an external pressure shock-absorbing device 600 is shown. A third force-bearing base r3 is disposed on the closed end 56 of the outer pipe 51 opposite to the chamber 53, and the third force-bearing base r3 is connected to a third compressive/tensile screw s3. A fourth force-bearing base r4 is disposed on the closed end 57 of the inner pipe 52 opposite to the chamber 53, and the fourth force-bearing base r4 is connected to a pressure-bearing base 62 by a pipe column body 61.

FIG. 7 illustrates a schematic diagram for a second embodiment of external pressure shock-absorbing device of bellows-type shock-absorbing device of the present invention. In the figure, an external pressure shock-absorbing device 700 is shown. The third force-bearing base r3 is disposed on the closed end 56 of the outer pipe 51 opposite to the chamber 53, and the third force-bearing base r3 is connected to the third compressive/tensile screw s3. The fourth force-bearing base r4 is disposed on the closed end 57 of the inner pipe 52 opposite to the chamber 53, and the fourth force-bearing base r4 is connected to the fourth compressive/tensile screw s4. A protrusion 63 is disposed on the fourth compressive/tensile screw s4, a fourth gap g4 is kept between the second end of the inner pipe 52 and the protrusion 63 of the fourth compressive/tensile screw s4. In addition, at least one position limiting block 64 arranged to resist a maximum displacement of the external pressure shock-absorbing device 700 is disposed between the outer pipe 51 and the inner pipe 52.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A bellows-type shock-absorbing device, comprising:
an outer pipe, a first end of the outer pipe being closed, a second end of the outer pipe being open, and a bellows being formed therebetween;
an inner pipe, a first end of the inner pipe being closed, a second end of the inner pipe being open, the inner pipe being disposed inside the outer pipe, a first gap being kept between the first end of the outer pipe and the first end of the inner pipe, and the second end of the outer pipe and the second end of the inner pipe being sealed to form a chamber between an outer wall of the inner pipe and an inner wall of the outer pipe, and an accommodating space being formed between the first end and the second end of the inner pipe; and
at least one orifice disposed on the surface of the outer pipe for injecting fluids.

2. The bellows-type shock-absorbing device of claim 1, wherein a first force-bearing base is disposed on the first end of the outer pipe opposite to the chamber.

3. The bellows-type shock-absorbing device of claim 2, wherein the first force-bearing base is connected to a first compressive/tensile screw.

4. The bellows-type shock-absorbing device of claim 3, wherein a second force-bearing base is disposed on the first end of the inner pipe opposite to the chamber.

5. The bellows-type shock-absorbing device of claim 4, wherein the second force-bearing base is connected to a second compressive/tensile screw.

6. The bellows-type shock-absorbing device of claim 5, wherein a first sleeve body is disposed around the outer pipe, one end of the first sleeve body is through the first compressive/tensile screw and is in contact with the first force-bearing base, the other end of the first sleeve body is correspondingly extended to the second compressive/tensile screw, and at least one position limiting block is disposed on the other end of the first sleeve body, a second gap is kept between the position limiting block and the second ends of the outer pipe and the inner pipe.

7. The bellows-type shock-absorbing device of claim 3, wherein a pressure-bearing base is connected to the second end of the outer pipe and the second end of the inner pipe, the pressure-bearing base is arranged to seal the second end of the outer pipe and the second end of the inner pipe.

8. The bellows-type shock-absorbing device of claim 7, wherein a second sleeve body is disposed around the outer pipe, one end of the second sleeve body is arranged through the first compressive/tensile screw and is in contact with the first force-bearing base, and the other end of the second sleeve body is correspondingly extended to the bellows.

9. A bellows-type shock-absorbing device, comprising:
an outer pipe, a first end of the outer pipe being closed, a second end of the outer pipe being open.
an inner pipe, a first end of the inner pipe being closed, a second end of the inner pipe being open, and a bellows being formed between both of the ends, the inner pipe being disposed inside the outer pipe, a third gap being kept between the first end of the outer pipe and the first end of the inner pipe, and the second end of the outer pipe and the second end of the inner pipe being sealed to form a chamber between an outer wall of the inner pipe and an inner wall of the outer pipe, and an accommodating space being formed between the first end and the second end of the inner pipe; and
at least one orifice disposed on the surface of the outer pipe for injecting fluids.

10. The bellows-type shock-absorbing device of claim 9, wherein a third force-bearing base is disposed on the first end of the outer pipe opposite to the chamber.

11. The bellows-type shock-absorbing device of claim 10, wherein the third force-bearing base is connected to a third compressive/tensile screw.

12. The bellows-type shock-absorbing device of claim 11, wherein a fourth force-bearing base is disposed on the first end of the inner pipe opposite to the chamber.

13. The bellows-type shock-absorbing device of claim 12, wherein the fourth force-bearing base is connected to a pressure-bearing base by a pipe column body.

14. The bellows-type shock-absorbing device of claim 12, wherein the fourth force-bearing base is connected to a fourth compressive/tensile screw, a protrusion is disposed on the fourth compressive/tensile screw, a fourth gap is kept between the second end of the inner pipe and the protrusion of the fourth compressive/tensile screw.

15. The bellows-type shock-absorbing device of claim 14, wherein at least one position limiting block is disposed between the outer pipe and the inner pipe.
